(19) United States
(12) Patent Application Publication
(10) Pub. No.: US 2024/0408578 A1
(43) Pub. Date: Dec. 12, 2024

(54) PROCESSES AND SYSTEMS FOR REGENERATION OF SORBENT FOR USE IN CAPTURE OF CARBON DIOXIDE

(71) Applicant: SHELL USA, INC., Houston, TX (US)

(72) Inventors: Sayee Prasaad BALAJI, Amsterdam (NL); Timothy NISBET, Amsterdam (NL)

(21) Appl. No.: 18/702,364

(22) PCT Filed: Nov. 10, 2022
(86) PCT No.: PCT/EP2022/081442

§ 371 Date: Apr. 18, 2024

(30) Foreign Application Priority Data
Nov. 12, 2021 (EP) 21207908.1

(51) Int. Cl. B01J 20/34; B01D 53/04

(52) U.S. Cl. CPC B01J 20/3458; B01D 53/0446; B01D 2253/342; B01D 2257/504; B01D 2259/45

(57) ABSTRACT

This invention provides processes and systems for the regeneration of a supported sorbent material for use indirect air capture of carbon dioxide from air. The process comprises the steps of introducing a stream of regenerating gas or vapour to the supported sorbent in a first direction thereby defining an axis of flow; and collecting the stream of regenerating gas or vapour and recycling it through the supported sorbent at least one or even multiple further times, wherein the supported sorbent comprises an amount of adsorbed carbon dioxide that is released upon exposure to the stream.

### FIELD OF THE INVENTION

This invention relates to systems and apparatus for the capture of carbon dioxide from a gaseous feedstream such as air.

### BACKGROUND OF THE INVENTION

Direct air capture (DAC) of carbon dioxide from the air has been proposed as one way of addressing human induced climate change. Current estimates place global levels of carbon dioxide in the atmosphere at around 420 parts per million. This is expected to rise to around 900 parts per million by the end of the 21^{st} century. Hence, DAC represents one of a range of technologies that can be employed to reduce the environmental impact of greenhouse gases like carbon dioxide and help the transition to a low carbon global economy.

Typical DAC systems take large quantities of air (or other conditioned gaseous atmosphere) which is pumped as a feedstream through a unit that contains a sorbent substance that removes the carbon dioxide from the feedstream under ambient conditions. Over time the sorbent becomes loaded with captured carbon dioxide. Next, the captured carbon dioxide in the sorbent is extracted from the sorbent in a regeneration step. Regeneration may involve thermal or chemical processes depending upon the type of sorbent material that is selected for use in the DAC. For example, amine-functionalised resins such as polyethyleneamines (PEA) can serve as effective sorbents that are regenerated with steam at temperatures of above 50° C., typically up to or around 130° C. Upon regeneration the captured carbon dioxide is released from the sorbent and can be used to manufacture sustainable fuels, specialty chemicals, in food and beverage production or in carbon capture and sequestration (CCS) in order to create a net negative carbon process.

The sorbent is typically arranged in assemblies of a plurality of monoliths or beds. Each monolith or bed is formed of a highly porous substrate, such as an alumina or silica, having a high proportion of a sorbent such as an inorganic carbonate or an amine on its available surfaces to facilitate carbon dioxide adsorption. A single movable regeneration unit passes across the monolith or bed on a track and initiates a regeneration process as and when the sorbent reaches desired saturation with adsorbed carbon dioxide. The regeneration unit will typically apply a gas or vapour stream which is used to remove the carbon dioxide from the sorbent. A vapour stream commonly used is steam, typically up to or around 130° C. and at a pressure around atmospheric pressure—e.g. between 0.7/70 kPa and 1.3 bar/130 KPa. The effect of the steam is to heat the monolith or bed and in so doing to strip the sorbent of carbon dioxide. Steam has the advantage of being relatively inert as well as easily recoverable and separable. The released carbon dioxide is mixed with steam to produce a condensate which is then passed to a collection system where residual steam may be passed through a heat exchanging condenser such that water is removed leaving only an enriched stream of gaseous carbon dioxide as the output. The process as described is summarised in FIG. 1. In the invention as further described below the regeneration stream is taken to be steam, but the principles described also hold for any other gas or vapour regeneration medium.

U.S. Pat. No. 10,512,880 describes an arrangement whereby monolith beds are arranged in a rotating drum around a static regeneration unit thereby forming a closed loop track. The monoliths may be rotated along the track in succession to allow for continuous phases of adsorption and regeneration.

International Patent Application No. PCT/EP2019/064609 (published as WO-A-2019/238488) describes a cyclic adsorption/desorption process using a sorbent material in a monolith structure for adsorbing gaseous carbon dioxide from a gaseous feedstream, in which the desorption occurs under a reduced pressure of 20-400 mbar (0.3-5.8 psi) and an elevated temperature of between 5° and 180° C.

There is a need to provide improved systems and processes that can operate continuously providing efficient phases of absorption and desorption of carbon dioxide from monolith sorbent beds. These and other objectives will become apparent from the disclosure provided herein.

### SUMMARY OF THE INVENTION

The present inventors have found that the process of carbon dioxide desorption and subsequent downstream concentration and separation can be improved surprisingly by recycling some or all the regenerant gas or vapour (e.g. steam and carbon dioxide) applied to a monolith or sorbent bed during regeneration. In this way the regenerant gas or vapour is passed through at least one monolith or bed more than once.

Accordingly, a first aspect of the invention provides a process for the regeneration of a supported sorbent material for use in capture of carbon dioxide from a gaseous feedstream such as air, the process comprises the steps of:
i. introducing a stream of regenerating gas or vapour to the supported sorbent in a first direction thereby defining an axis of flow; and
ii. collecting the stream of regenerating gas or vapour and recycling it through the supported sorbent at least one further time, in a second direction that is substantially opposite to the axis of flow,
   wherein the supported sorbent comprises an amount of adsorbed carbon dioxide that is released upon exposure to the regeneration gas or vapour.

Suitably the gaseous feedstream comprises air. Typically, the stream of regenerating gas or vapour comprises steam. Optionally, in step (ii) the stream of regenerating gas or vapour is cycled multiple times through the supported sorbent in alternating first and second directions. The stream of regenerating gas or vapour is cycled at least three times through the solid sorbent of a specific monolith slab or bed, suitably at least five times.

In embodiments of the invention the sorbent material is supported within at least one bed or block and suitably the bed or block comprises a so-called monolith block. In further embodiments, the sorbent material is comprised within a plurality of adjacent beds or blocks, such as one or more adjacent monolith blocks—e.g. arranged in one or more rows or one or more stacks.

In specific embodiments, the sorbent material comprises a substance selected from an inorganic carbonate and/or an amine (e.g. a polyamine).

A second aspect of the invention provides a system for capture of carbon dioxide from a gaseous feedstream such as air, the system comprising:
at least one sorbent material, wherein the sorbent material is supported within a support bed or block, and wherein the support bed or block is comprised of a porous material, and the support bed or block possesses a first face that receives the air feedstream and a second face from which the air feedstream exits the support bed or block depleted of carbon dioxide;
at least a first inlet that directs the air feedstream to the first face of the support bed or block;
at least a first outlet that receives the carbon dioxide depleted feedstream from the second face of the support bed or block;
at least one impeller for maintaining a flow of the air feedstream through the system;
   characterized in that, the system comprises a regenerator unit that delivers a supply of gas or vapour to the support bed or block in order to regenerate the sorbent material and release adsorbed carbon dioxide to a vent, wherein the regenerator unit cycles the gas or vapour through the support bed or block multiple times, in at least a first direction that is coaxial to the flow of the air feedstream and subsequently in at least a second opposing direction to the first direction.

Optionally, the regenerator unit cycles the gas or vapour through the support bed or block in multiple first direction and second directions.

In specific embodiments, the support bed or block is comprised within one or more monolith blocks or a plurality of adjacent monolith blocks.

According to embodiments of the invention the process and systems are able to reduce axial mixing of regenerant with an entrained gas comprised within the support bed or block. In a specific embodiment of the invention, the reduction in axial dispersion of air entrained in the sorbent with liberated carbon dioxide is defined by a Peclet number of at least 10, suitably greater than 10, typically greater than 20, and optionally greater than 50, suitably at least 100.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any described embodiment can be combined with other embodiments in any way and/or combination, unless such features are incompatible.

### BRIEF DESCRIPTION OF THE DRAWINGS

FIG. 1 illustrates a schematic representation of a DAC system comprising one row of monolith adsorber blocks comprised within an absorber unit, together with a mobile regenerator unit.

FIG. 2 shows a schematic top-down representation of a prior art system with two rows of monoliths, in each row the two outer monolith blocks are in the adsorption phase whereas the two central monoliths are subject regeneration by application of steam at a temperature of around 130° C. and at a pressure close to atmospheric.

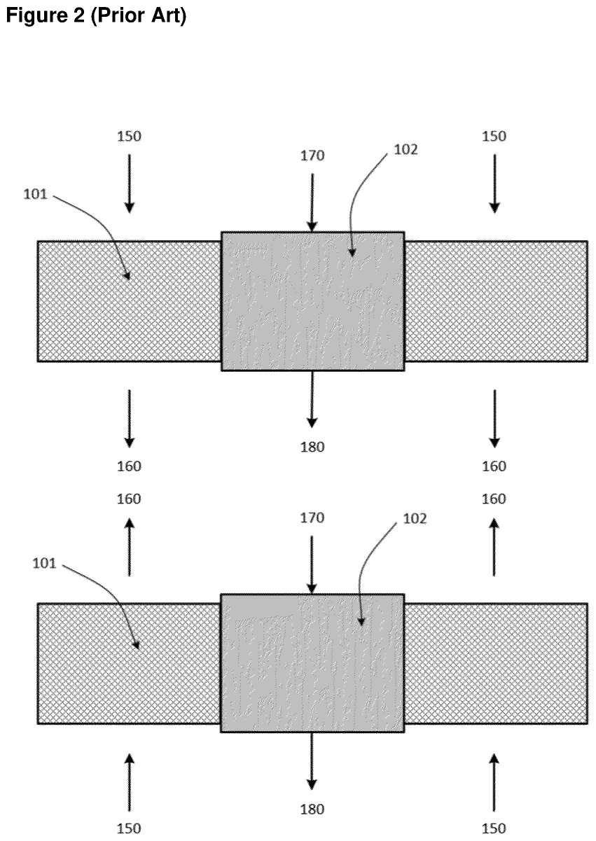

FIG. 3 shows a schematic representation of an embodiment of the present invention wherein a flow of regenerant steam and/or released carbon dioxide is recycled across each monolith block in at least three passes.

FIG. 4 shows a schematic representation of another embodiment of the present invention wherein a flow of regenerant steam and/or carbon dioxide is recycled across a first monolith block in at least three passes and then subsequently across an adjacent monolith block also with multiple passes.

### DETAILED DESCRIPTION OF THE INVENTION

In general terms the present invention provides system comprising an adsorber unit for capturing carbon dioxide from a gaseous feedstream such as air with a regenerable sorbent material. The sorbent material is subjected to a regeneration process that involves passing a gas or vapour stream, termed the “regenerant” and typically comprised of steam and/or regenerated carbon dioxide, across the sorbent in multiple passes.

For the purposes of promoting an understanding of the principles of the invention, reference will now be made to the embodiments illustrated in the accompanying drawings, which are described in more detail below. The embodiments disclosed herein are not intended to be exhaustive or limit the invention to the precise form disclosed in the following detailed description. The invention includes any alterations and further modifications in the illustrated devices and described methods and further applications of the principles of the invention as set forth in the claims.

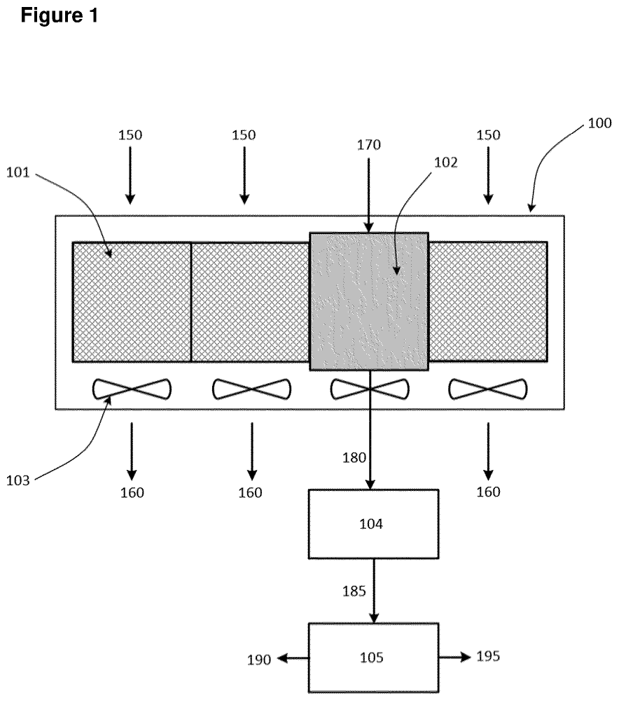

FIG. 1 shows a representation of a direct air capture (DAC) carbon dioxide adsorber unit 100 in top or plan view. The exemplary adsorber unit 100 comprises one or multiple rows of monolith beds or slabs 101 that are comprised of a sorbent material. The sorbent can be any described in the prior art, such as potassium carbonate or an amine. Suitable sorbents are described in e.g. X. Shi et al, Sorbents for the Direct Capture of CO2 from Ambient Air, Angew. Chem. Int. Ed. 2020, 59, 2-25. The sorbent is supported on a substrate such as an extruded mesoporous alumina (e.g. α or γ-alumina) or silica honeycomb monolith substrate. Hence, the monolith blocks 101 will suitably possess at least first and second faces, with feed gas 150 being received into the honeycomb structure of the monolith via the first outward face and leaving the block via the second inward face.

A feed gas 150 containing carbon dioxide is drawn into the unit through the monolith blocks by the action of impellers 103, such as fans. Typically, the feed gas 150 is air but in embodiments of the invention it may comprise a conditioned gas enriched with carbon dioxide, such as a flue exhaust gas from an industrial or biological process. As the feed gas 150 passes across the surfaces comprised within the monolith the carbon dioxide is adsorbed by the sorbent, with resultant carbon dioxide depleted gas 160 leaving the monolith and vented to the atmosphere.

Eventually as the sorbent material approaches desired saturation with adsorbed carbon dioxide there is a need to regenerate the sorbent material and strip away the carbon dioxide. The adsorber unit 100 includes a movable regenerator unit 102 that is able to move along a track and encompasses an adjacent pair of monolith blocks at any given time whilst allowing neighbouring monolith blocks to continue to adsorb carbon dioxide. In this way the cycle of adsorption and regeneration within the DAC unit can occur continuously without interruption and significant downtime. It will be appreciated that the configuration of a movable regenerator unit 102 depicted in FIG. 1 is merely exemplary and alternative assemblies of monoliths and regenerator units are possible, for example, as mentioned previously U.S. Pat. No. 10,512,880 describes an arrangement whereby monolith beds are arranged in a rotating drum around a static regeneration unit.

The regenerator unit 102 comprises an inlet that is in fluid communication with a source of a regenerant vapour, such as steam via a low-pressure (LP) steam line 170. Typically, the steam may be derived from an external heat exchange system that is able to heat a supply of water by way of a boiler and generate output of LP steam. The LP steam may also be obtained as output from a back pressure turbine or reclaimed from one or more parallel industrial processing apparatus and systems that generate excess or waste energy, suitably in the form of thermal energy, such as comprised within steam or other heated fluids.

The regenerator unit further comprises at least one outlet that is in fluid communication with a vent line 180 that comprises a vacuum pump 104. In this way steam may be introduced and drawn into the regenerator unit from the LP steam line via reduction of pressure. Alternatively, steam of slightly elevated pressure just above atmospheric pressure (e.g. >1 bar), suitably around 1.3 bar/130 KPa (around 18.9 psi), and at a temperature of around 100 to 130 C may be introduced directly into the regenerator unit.

The inlet may comprise a plenum chamber in fluid communication with a manifold arrangement to ensure even dispersion of steam supply to a first face of a monolith block. Alternatively, the inlet may lead directly to the first face of the monolith. The outlet receives gas vented from a second face of the monolith block. The outlet may also comprise a manifold arrangement to ensure collection of displaced air, at first, followed by the exhaust mixture of stripped carbon dioxide and steam. Displaced air 190 may be vented to the atmosphere via a three-way valve 105 downstream of the vent line 185. The exhaust mixture of stripped carbon dioxide and steam 195 may be passed through a heat exchange system to produce condensate that is removed as water and recycled for steam generation. The remaining concentrated carbon dioxide gas stream may be subjected to further processing before it is conveyed out of the DAC unit where it may be utilised in a range of industrial/agricultural processes or stored or sequestered as necessary.

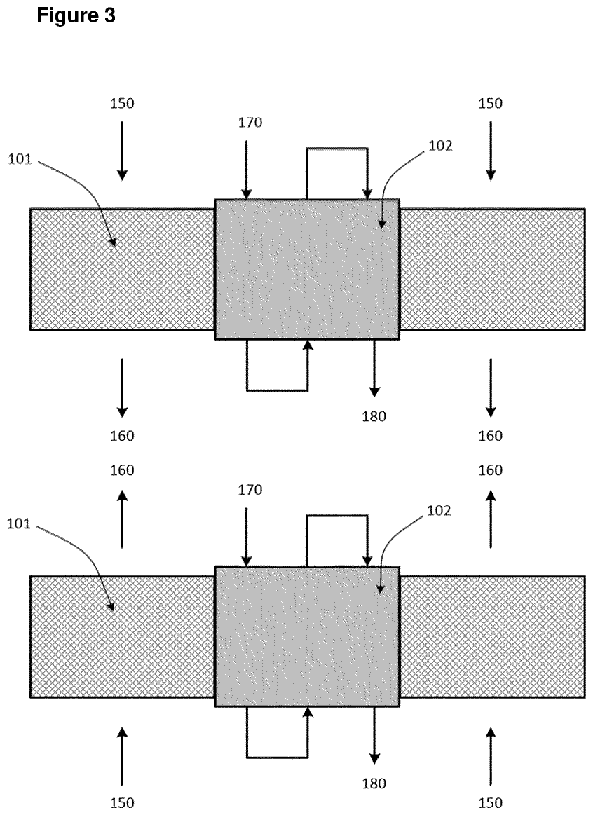

In an embodiment of the present invention shown in FIG. 3, the regenerator unit 102 comprises an inlet that is in fluid communication with a source of regenerant, such as steam via an LP steam line 170, and at least one outlet that is in fluid communication with a vent line 180 as described previously. The inlet may comprise a plenum chamber in fluid communication with a manifold arrangement that ensures even dispersion of steam supply to a first face of a monolith block that is to be stripped of adsorbed carbon dioxide. Alternatively, the inlet may lead directly to the first face of the monolith. In a first phase, steam introduced via the inlet 170 will heat up the monolith and will displace incumbent entrained air within the monolith. Understandably, it is advantageous to displace this air as quickly and completely as possible to enable the regeneration process to occur at peak efficiency and to also reduce the dilution of stripped carbon dioxide with incumbent air. Surprisingly it has been found that displacement of this entrained air can be facilitated by returning the regenerant LP steam supply and/or the regenerated carbon dioxide across the monolith block again after it has passed through a first time. Return of the steam supply and/or the regenerated carbon dioxide can be facilitated by configuring a manifold arrangement within the outlet such that the flow of gas passing out of the second face of the monolith block is returned in a direction that is opposite to the prevailing flow of feed gas in normal operation. In this way steam and/or the regenerated carbon dioxide is returned to inlet face, suitably the plenum chamber in the inlet manifold. Subsequent reversal of flow will then permit return of the steam and/or the regenerated carbon dioxide for at least a third pass across the monolith block before entering the vent line 180. The invention provides, therefore, systems and processes that effect recirculation (e.g. via multiple passes) of a regenerant, such as a steam supply and/or the regenerated carbon dioxide, across a monolith sorbent block in order to displace entrained air and maximise carbon dioxide stripping of the regenerable sorbent material.

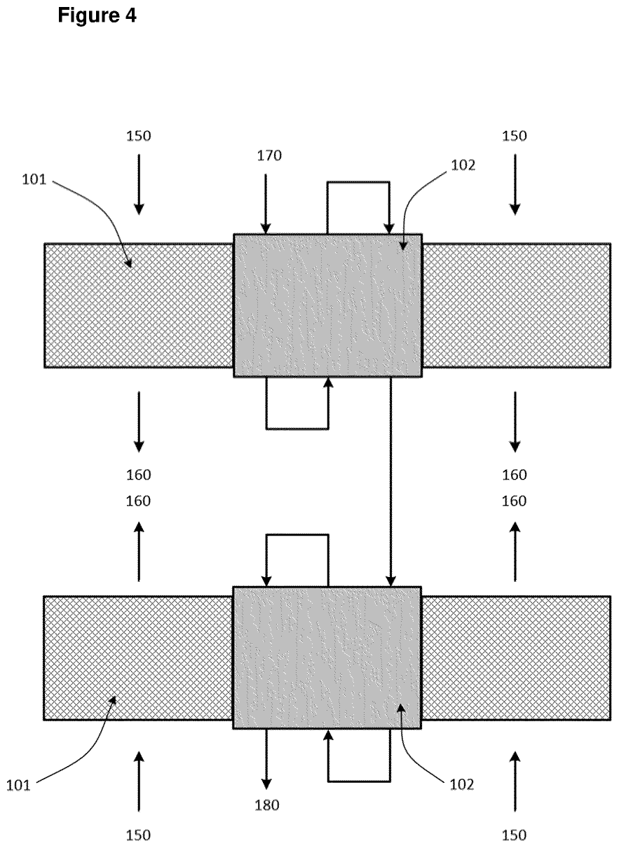

In a further embodiment as shown in FIG. 4, the steam vented from a first monolith block may be directed to a second adjacent monolith block prior to entering the vent line. Hence, a regenerant steam supply and/or the regenerated carbon dioxide may make multiple passes through multiple monolith blocks prior to entering the vent line. In further embodiments, it is possible to place stacks of the DAC absorber units in assemblies adjacent or on top of each other to facilitate the set up shown in FIG. 4. Hence, the recycling of regenerative steam and/or the regenerated carbon dioxide may occur within more than one regenerator units that are in fluid communication with each other, and also between multiple DAC absorber units. This allows for maximisation of heat integration within and between regeneration units as well as reducing the overall volume of steam required to achieve a high level of efficient carbon dioxide stripping.

It will be appreciated that in conventional DAC processes, very large amounts of feed gas (e.g. air) needs to be passed through the monolith or bed to capture sufficient carbon dioxide. To avoid excessive power consumption it is also necessary to operate with a low pressure drop, which typically limits air velocity in the monolith or bed to below 10 m/s, more typically below 5 m/s. At these velocities the airflow is close to plugflow, with little axial dispersion in the monolith or bed. During steam regeneration, however, the flow is typically much lower, in order to limit the amount of steam needed. At these lower flows, axial dispersion in the monolith or bed can be significant. This leads to mixing of the air trapped in the monolith or bed with the released carbon dioxide with the result that the carbon dioxide that is released is less pure or that more carbon dioxide is lost when venting the first portion of the outlet vapour, either of which reduce the efficiency of the DAC process. In addition, the temperature of the outlet regenerant gas or vapour quickly reaches a temperature close to the inlet temperature, and this needs to be continued for some time to effectively strip the carbon dioxide from the sorbent in the monolith or bed. Without wishing to be bound by theory, it is believed that in the present invention the multi-pass flow of the regenerant prevents both of the aforementioned disadvantages. Firstly, the velocity in the monolith is increased, e.g. 3 times for a 3-pass system. This means that there is less axial dispersion and hence the flow is closer to plug-flow, giving a more piston-like displacement of entrained air and allowing more efficient venting. The degree of axial dispersion can be expressed as the axial Peclet number (defined as the velocity multiplied by the depth of the monolith block or bed divided by the molecular diffusivity of the regenerant gas or vapour). According to embodiments of the present invention, the Peclet number of the regenerant flow should be at least 10, suitably greater than 10, typically greater than 20, and optionally greater than 50, more suitably above 100. In specific embodiments of the systems or processes of the invention, the reduction in axial dispersion air entrained in the sorbent with liberated carbon dioxide is defined by a Peclet number of not less than 100. Additionally, the longer flow path resulting from the present invention means that the outlet regenerant gas/vapour reaches a temperature close to the inlet temperature later than in a single pass system, giving more efficient use of the heat content of the regenerant used.

According to the present invention, processes for the operation of the described systems are provided. The processes are for the regeneration of a supported sorbent material that may be comprised within a monolith slab or bed, or within some other form of sorbent support e.g. granular/particulate bed. The process comprises the steps of:
i. introducing a stream of regenerating gas or vapour to the supported sorbent in a first direction thereby defining an axis of flow; and
ii. collecting the stream of regenerating gas or vapour and recycling it through the supported sorbent at least one further time, in a second direction that is opposite to the axis of flow,
   wherein the supported sorbent comprises an amount of adsorbed carbon dioxide that is released upon exposure to the stream.

In a specific embodiment the process comprises the step (ii) in which the stream of regenerating gas or vapour is cycled multiple times through the supported sorbent in alternating first and second directions. Optionally, the stream of regenerating gas or vapour is cycled at least three times through the solid sorbent of a specific monolith slab or bed, suitably at least five times.

In a further embodiment of the invention, a process is provided whereby a plurality of supported sorbent materials that may be comprised within a plurality of monolith slabs or beds, or within some other form of sorbent support, are arranged such that the stream of regenerating gas or vapour is recycling through each of the supported sorbent multiple times.

In an embodiment of the invention a device is provided to facilitate the required multi-pass flows of the regenerant gas or vapour stream across the monolith or bed. The device can comprise two manifolds which are applied to the outward faces of the bed or monolith. For example, for a 3-pass design, an inlet stream will pass through an inlet line into a chamber/plenum located within the manifold that defines and corresponds to a one third area of a first face of the monolith or bed. The regenerant stream passes through the monolith or bed into a receiving chamber/plenum of the manifold located in registry with a two thirds area of the second face of the monolith. The receiving chamber diverts the regenerant stream back through the bed or monolith, such that it is received into a further chamber/plenum of the manifold located in registry with the first face but with an area that represent the remaining two thirds of the area of the first face, also without an exit line. In this way the regenerant stream is again diverted back through the bed or monolith, entering a final receiving chamber/plenum of the manifold in registry with the second face with an area of the balance of one third of the area of the face, that is in fluid communication with an exit/vent line. To prevent flow passing directly from adjacent chambers of the manifold on a single face, seals are provided against the face of the bed or monolith. These can be a of suitable material and construction, well known to those skilled in the art.

The invention will now be further illustrated by reference to the following non-limiting example.

### Example

### Modelled System and Process for Regeneration of Monolith DAC Sorbent

A sorbent used for capture of carbon dioxide from air is arranged in the form of a monolith block of depth 0.3 m. This monolith has a bulk density of 400 kg/m³, a monolith square channel dimension of 2.5*2.5 mm, an open frontal area of 75% and adsorbs 0.4 mol carbon dioxide per kg support during an adsorption cycle. For an adsorption time of 50 minutes the required airflow leads to a pressure drop across the monolith of 50 Pa. Flow is in the laminar regime. The sorbent is regenerated using steam at atmospheric pressure, which condenses on the sorbent and displaces the carbon dioxide. With a switching time of 1 minute from adsorption to desorption mode and back, and a total cycle time of 1 hour, carbon dioxide is liberated during 8 minutes. It is assumed that the flow rate of steam at the inlet and that of carbon dioxide at the outlet are the same (i.e. all steam condenses during this phase). As flow will be laminar the effective axial diffusivity will be about 0.00025 m²/s, as described in G. Ozkan and G. Doku, A dynamic study on axial dispersion and adsorption in catalytic monoliths, Ind. Eng. Chem. Res. 1997, 36, 4734-4739. From the amount of carbon dioxide liberated and the channel dimensions velocities can be calculated. This can be done for a system with 1, 2, 3, 4 and 5 passes of regenerant steam/carbon dioxide through the system. Axial Peclet numbers (the velocity multiplied by the total path length divided by the effective axial diffusivity) can also be calculated. If the Peclet number is low, axial dispersion will lead to mixing of air entrained in the sorbent with liberated carbon dioxide, which is undesirable. Higher Peclet numbers result in piston-like plugflow of entrained air and far lower mixing/dilution of desorbed carbon dioxide. Modelled results are given in Table 1 below:

TABLE 1

| Number of passes | 1 | 2 | 3 | 4 | 5 |
|---|---|---|---|---|---|
| Velocity (m/s) | 0.0044 | 0.0088 | 0.0131 | 0.0175 | 0.0219 |
| Total bed depth (m) | 0.3 | 0.6 | 0.9 | 1.2 | 1.5 |
| Axial Peclet number | 5 | 21 | 47 | 84 | 131 |

1. A process for the regeneration of a supported sorbent material for use in capture of carbon dioxide from an air feedstream, the process comprises the steps of:
i. introducing a stream of regenerating gas or vapour to the supported sorbent in a first direction thereby defining an axis of flow; and
ii. collecting the stream of regenerating gas or vapour and recycling it through the supported sorbent at least one further time, in a second direction that is substantially opposite to the axis of flow,
wherein the supported sorbent comprises an amount of adsorbed carbon dioxide that is released upon exposure to the regeneration gas or vapour.

2. The process as claimed in claim 1, wherein in step (ii) the stream of regenerating gas or vapour is cycled multiple times through the supported sorbent in alternating first and second directions.

3. The process as claimed in claim 1, wherein the sorbent material is supported within a bed or block and suitably the bed or block comprises a monolith block.

4. The process as claimed in claim 1, wherein the supported sorbent material is comprised within a plurality of adjacent beds or blocks.

5. The process as claimed in claim 1, wherein the stream of regenerating gas or vapour comprises steam.

6. The process as claimed in claim 1, wherein sorbent material comprises a substance selected from an inorganic carbonate and an amine.

7. The process as claimed in claim 2, wherein the stream of regenerating gas or vapour is cycled at least three times through the solid sorbent of a specific monolith slab or bed, suitably at least five times.

8. A system for capture of carbon dioxide from an air feedstream, the system comprising:
at least one sorbent material, wherein the sorbent material is supported within a support bed or block, and wherein the support bed or block is comprised of a porous material, and the support bed or block possesses a first face that receives the air feedstream and a second face from which the air feedstream exits the support bed or block depleted of carbon dioxide;
at least a first inlet that directs the air feedstream to the first face of the support bed or block:
at least a first outlet that receives the carbon dioxide depleted feedstream from the second face of the support bed or block:
at least one impeller for maintaining a flow of the air feedstream through the system:
characterized in that, the system comprises a regenerator unit that delivers a supply of gas or vapour to the support bed or block in order to regenerate the sorbent material and release adsorbed carbon dioxide to a vent, wherein the regenerator unit cycles the gas or vapour through the support bed or block multiple times in at least a first direction that is coaxial to the flow of the air feedstream and subsequently in at least a second opposing direction to the first direction.

9. The system of claim 8, wherein the regenerator unit cycles the gas or vapour through the support bed or block in multiple first direction and second directions.

10. The system of claim 8, wherein the support bed or block is comprised within one or more monolith blocks or a plurality of adjacent monolith blocks.

11. The system as claimed in claim 8, where the regenerator unit produces steam.

12. The system as claimed in claim 8, wherein the sorbent comprises a substance selected from an inorganic carbonate and/or an amine.
